(19) United States
(12) Patent Application Publication
(10) Pub. No.: US 2013/0290191 A1
(43) Pub. Date: Oct. 31, 2013

(54) METHOD OF TRANSFERRING ACCESS RIGHTS TO A SERVICE FROM ONE DEVICE TO ANOTHER

(71) Applicants: Paul Dischamp, Nanterre (FR); Emmanuelle Dottax, Nanterre (FR)

(72) Inventors: Paul Dischamp, Nanterre (FR); Emmanuelle Dottax, Nanterre (FR)

(73) Assignee: OBERTHUR TECHNOLOGIES, Colombes (FR)

(21) Appl. No.: 13/869,347

(22) Filed: Apr. 24, 2013

(30) Foreign Application Priority Data
Apr. 24, 2012 (FR) 1253765

(51) Int. Cl. H04L 29/06

(52) U.S. Cl. CPC H04L 63/061
USPC 705/51

(57) ABSTRACT

A method of transfer transferring a right to access a service from a device (2) of a lender (P) to a device (25) of a borrower (E), the method comprising:
holding an access right to a service;
obtaining authentication data associated with the borrower (E) or the borrower's device (25);
duplicating said at least one access right (D1-D2);
using a cryptographic key associated with the device (2) of the lender (P) to calculate a cryptogram containing authentication data and duplicated rights; and
sending the cryptogram to the device (25) of the borrower (E).

Correspondingly, the invention also provides a method of controlling access to such a service by a service provider, and also a method of managing a transfer of such access rights from the device (2) of the lender (P) to the service provider.

### BACKGROUND OF THE INVENTION

The present invention relates to transferring (or lending) a right to access a service, and it relates more particularly to transferring such rights from the device of a lender to the device of a borrower so that the borrower can access the service(s) in question.

Authentication and security services, e.g. of the kind involving near-field communication (NFC) have become widely deployed in the last few years These services are to be found in numerous everyday applications such as controlling the doors of a house or a vehicle, security gates, public transport, access to Internet services, . . . .

For example, there now exist cars that enable a user to use an electronic key (or a digital key) for automatically opening the doors of the vehicle. Numerous other functions or “services” can be triggered by means of such a key, for example controlling starting the engine, controlling a global positioning system (GPS) function, controlling a car radio, etc.

In order to trigger such services, it is necessary to possess the corresponding access rights (or utilization rights). Typically, the owner of a vehicle uses a portable device, e.g. a cell phone, that hosts a dedicated application for communicating with the corresponding service provider (i.e. the vehicle in this example). This control device allows the proprietor to be identified with the service provider (i.e. the vehicle terminal hosting the corresponding application) and allows the proprietor to request access to the services in compliance with the rights available to the proprietor.

Such a device for controlling rights is generally given to a single proprietor (e.g. of a vehicle). Third parties are generally not in a position to obtain freely rights giving access to service, in particular if the service is paid-for or private. However, a legitimate user may seek to lend certain access rights to a trusted third party so that that third party can also benefit from them. For example, if the proprietor seeks to lend a digital car key to a friend, the proprietor must also physically lend the portable device to that friend.

By way of example, patent document WO 2007/132056 discloses a system for loading a travel ticket into a portable device, but that mechanism does not allow for a lender to transfer a right to a third party.

Lending the access control device itself presents numerous drawbacks, with one of the most obvious being that the proprietor is no longer in a position to use the device throughout the duration of the loan. This lending operation is also limited by the number of devices available to the proprietor. Handing over the device also means that there is a risk to the proprietor in terms of security, since the proprietor can find it difficult to control access to the services in question in the absence of the device.

There therefore exists a need for a solution that is simple and fast and that enables personalized rights to access a service to be transferred from a lender to a third party (referred to as a borrower) so as to enable the borrower to exercise those access rights, i.e. to have access to the service(s) in question in compliance with the access rights that have been lent by the lender.

### OBJECT AND SUMMARY OF THE INVENTION

To this end, the present invention provides a transfer method for transferring a right to access a service to a device of a borrower, the method being performed by a device of a lender, comprising:

holding at least one access right to access a service enabling the lender's device to access the service in accordance with said at least one access right;

obtaining authentication data associated with the borrower or with the borrower's device;

duplicating said at least one access right;

using a cryptographic key associated with the lender's device to calculate a cryptogram from a message containing the authentication data and said at least one duplicated access right; and

sending the cryptogram to the borrower's device in order to transfer the duplicated access right thereto.

The invention enables the holder of rights to access a service to transfer certain of those rights to a trusted third party in the form of a loan. The transfer takes place using the lender's device in accordance with the invention. Once the rights have been selected they are duplicated and then transferred from a lender to a borrower so that both of them can then exercise the rights in question with the intended service. In other words, the transfer of a right does not deprive the lender of the right in question.

The invention advantageously enables the lender and the borrower to return their respective devices. The lender transfers access rights from the lender's device to the borrower's device, and the borrower can then exercise those rights using the borrower's own device with the service in question. An occasional user of a service can thus benefit from certain rights that have been transferred for this purpose.

The invention advantageously enables the lender to personalize the loan by freely selecting at least one access right from the rights available to the lender at the time of making the selection.

In a particular implementation, the transfer method further includes selecting at least one of the available access rights, said at least one access right that is duplicated during the duplication step being the right(s) selected during the selection step. In this way, it is possible to select at least one of a plurality of access rights held by the device of the lender and to duplicate only the selected access right(s).

The cryptogram is preferably sent over a short-range point-to-point communications connection of the NFC type, e.g. in compliance with the ISO14443 standard that has a range of a few centimeters, i.e. about 1 centimeter (cm) to about 10 cm. Alternatively, the short-range point-to-point communications connection that is used may be of the Bluetooth® or of the Zigbee type.

More particularly, the invention preferably makes use of short-range point-to-point communications interfaces (preferably of the NFC, Bluetooth®, or Zigbee type) for communicating between the borrower's device and the lender's device. In this way, in order to provide communication in accordance with the invention between the lender's device and the borrower's device, there is no need for any communications network (of the local area network (LAN), wireless local area network (WLAN), or public switched telephone network (PSTN) type, for example).

In a first implementation, the transfer method further comprises selecting an identifier of the borrower's device, wherein the authentication data obtained from the selected identifier and corresponds to a public cryptographic key associated with the borrower's device.

The term “associated” is used herein to mean that the public cryptographic key is sent to third parties by the borrower's device and that it corresponds to a secret cryptographic key that is held by the borrower's device.

This implementation may make use of asymmetric type encryption making it possible to secure the exchange of authentication data from the borrower's device to the lender's device.

In a second implementation, the authentication data is an identity code received from the borrower's device. This code corresponds to a serial number of the equipment (cell phone etc.), for example.

In a third implementation, the transfer method further includes selecting an identifier of the borrower's device, wherein the authentication data is obtained from the selected identifier and corresponds to a biometric signature of the borrower.

This biometric signature comprises at least one of: capturing a digital fingerprint and capturing a given image (e.g. of a face).

Furthermore, the cryptographic key associated with the lender's device may be a secret cryptographic key.

In a particular implementation, the various steps of the transfer method are determined by computer program instructions.

Consequently, the invention also provides a computer program on a data medium or recording medium), the program being suitable for being performed in a device such as a cell phone, or more generally in a computer, the program including instructions adapted to performing steps of a transfer method as described above.

The invention also provides as computer-readable recording medium (or data medium), that contains instructions of a computer program as mentioned above.

Correspondingly, the invention provides a control method for controlling access to a service, the method being performed by a service provider, said control method comprising:

receiving a first cryptogram from a device of a borrower, the first cryptogram being calculated on the basis of a first cryptographic key associated with a device of a lender, said first cryptogram comprising first authentication data associated with the borrower or with the borrower's device together with at least one access right transferred by the lender's device to give access to a service;

authenticating the first cryptogram using a second cryptographic key matching said first key in order to verify that said first cryptogram does indeed come from the lender's device;

authenticating the borrower or the borrower's device by receiving second authentication data of the borrower or of the borrower's device and verifying the authenticity of the borrower's device from the first authentication data extracted from said first cryptogram and from the received second authentication data; and

deciding to allow the borrower access to the service in compliance with said at least one transferred access right if, and only if, said authentication steps take place successfully.

The above-mentioned advantages and comments relating to the transfer method and its particular implementations apply analogously to the access control method of the invention and to its respective implementations.

In preferred manner, the first cryptogram from the borrower's device and the second authentication data are received via an NFC, Bluetooth®, or Zigbee short-range point-to-point communications connection.

When NFC connection is used, e.g. in compliance with the ISO14443 standard, its range is a few centimeters, i.e. about 1 cm to about 10 cm.

In an aspect of the invention, the first key associated with the lenders device is a secret cryptographic key and the second key is a public cryptographic key matching said secret key. Under such circumstances, an asymmetric algorithm may also be implemented.

In another aspect of the invention, the first and second cryptographic keys are identical secret keys shared by the lender's device and by the service provider. Under such circumstances, a symmetrical algorithm may be used.

In a second implementation, the second authentication data is a second cryptogram coming from the borrower's device, and verification of the authenticity of the borrower's device comprises verifying the received second cryptogram using the first authentication data as extracted from the received first cryptogram, the first authentication data being a public cryptographic key that is associated with the borrower's device.

The term “associated” is used herein to mean that the public cryptographic key is sent to third parties by the borrower's device and that it corresponds to a secret cryptographic key held by the borrower's device.

In a third implementation, the first authentication data extracted from the first cryptogram is a first identity code and the received second authentication data is a second identity code, and verification of the authenticity of the borrower's device comprises comparing the first and second identity codes. This comparison serves for example to determine whether there is a match between the first and second identity codes.

In another implementation, the first authentication data extracted from the received first cryptogram is a first biometric signature, and the received second authentication data is a second biometric signature, and the authenticity of the borrower's device is verified by comparing the first and second biometric signatures.

In a particular implementation, the various steps of the transfer method are determined by computer program instructions.

Consequently, the invention also provides a computer program on a data medium (or recording medium), the program being suitable for being performed in a device such as a terminal, or more generally in a computer, the program including instructions adapted to performing steps of an access control method as described above.

The invention also provides a computer-readable recording medium (or data medium), that contains instructions of a computer program as mentioned above.

In addition, invention provides a method of managing a transfer of at least one access right giving access to a service, the method comprising:

transferring at least one access right to service to a device of a borrower, the method being performed by a device of a lender as defined above;

transferring said at least one access right from the device of the borrower to an access provider (or service provider); and

the access provider controlling access of the borrower to the service by an access control method as defined above.

In a particular implementation, the various steps of the management method are determined by computer program instructions.

Consequently, the invention also provides a computer program on a data medium (or recording medium), the program being suitable for being performed in devices such as terminals, more generally in computers, the program including instructions adapted to performing steps of a management method as described above.

The invention also provides a computer-readable recording medium (or data medium), that contains instructions of a computer program as mentioned above.

It should be observed that the above-mentioned programs may use any programming language, and be in the form of source code, object code, or code intermediate between source code and object code, such as in a partially compiled form, or in any other desirable form.

Furthermore, the above-mentioned recording media may be any entity or device capable of storing the program. For example, the medium may comprise storage means such as a flash memory or a read only memory (ROM), e.g. a compact disk (CD) ROM or a microelectronic circuit ROM, or indeed a magnetic recording medium, e.g. a floppy disk or a hard disk.

Furthermore, the recording media may correspond to a transmissible medium such as an electrical or optical signal suitable for being conveyed via an electrical or optical cable, by radio, or by other means. The program of the invention may in particular be downloaded from an Internet type network.

Alternatively, the recording media may correspond to an integrated circuit in which the program is incorporated, the circuit being adapted to execute or to be used in the execution of the method in question.

The present invention also provides a lender's device including means suitable for performing the steps of the transfer method of the invention.

The invention also provides a service provider including means suitable for performing the steps of the access control method of the invention.

### BRIEF DESCRIPTION OF THE DRAWINGS

Other characteristics and advantages of the present invention appear from the following description made with reference to the accompanying drawings that show an implementation having no limiting character. In the figures:

FIG. 1A is a diagram of the hardware architecture of the device of a lender and the device of a borrower in an implementation of the invention;

FIG. 1B is a diagram showing the architecture of the device of the service provider;

FIGS. 2A and 2B show an implementation of the present invention;

FIG. 3, in the form of a flow chart, shows the main steps of a method of transferring an access right and a method of controlling access to a service in a first implementation of the invention;

FIG. 4 is a diagram in the form of a data table showing the selection of rights by a lender on the lender's device; and

FIG. 5, in the form of a flow chart, shows the main steps of a method of transferring an access right and a method of controlling access to a service in a second implementation of the invention.

### DETAILED DESCRIPTION OF IMPLEMENTATIONS

The present invention relates to the transfer (or loan) of a right to access a service, and more particularly it relates to transferring such rights from the device of a lender to the device of a borrower so that the borrower can access the service in question.

In this document, implementations of the invention are described in the context of accessing the functions of a car that a lender seeks to make available to a trusted borrower. As mentioned in detail below, It should nevertheless be understood that the invention applies more generally to lending rights to access any service, the access to the service being under the control of an appropriate service provider (or access provider).

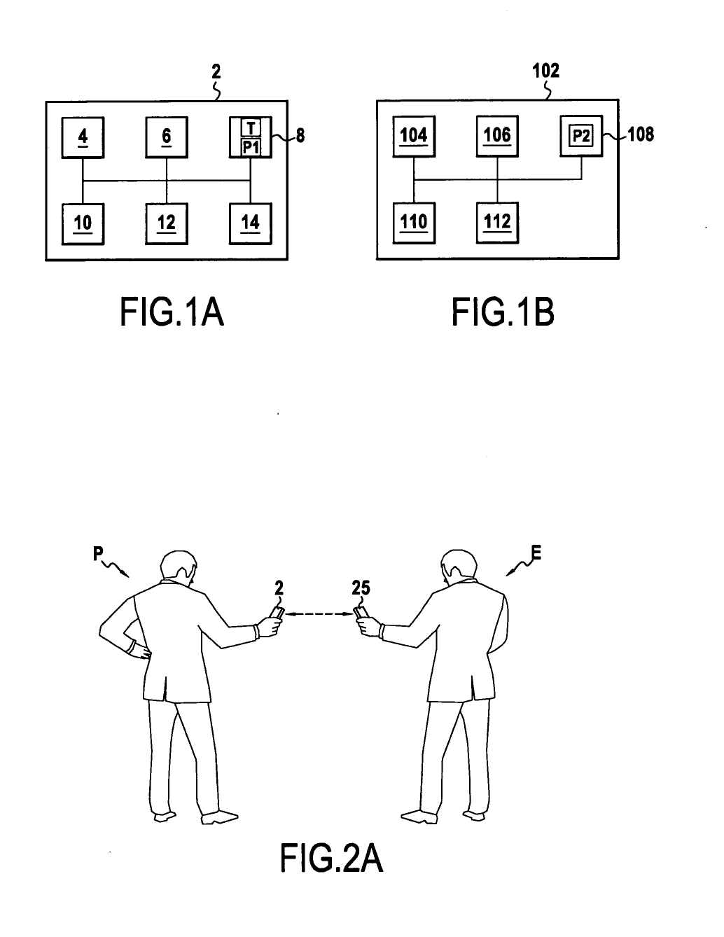

FIG. 1A is a diagram showing the hardware architecture of a device of a lender in a particular implementation of the invention. In this example, the lender's device 2 is a portable device such as a cell phone, a safety module, or a controller, for example. It will nevertheless be understood that the device may take on any appropriate form.

More particularly, the lender's device 2 comprises a microprocessor 4, a ROM 6, a rewritable non-volatile memory 8 (e.g. an electrically erasable and programmable ROM (EEPROM)), a rewritable volatile memory 10 (also known as random access memory (RAM)), a communications interface 12, and a man/machine interface 14. The various elements of the device 2 are connected together by a bidirectional bus.

By way of example, the communications interface 12 is a short-range point-to-point communications interface. By way of example, the communications interface 12 is an NFC interface, e.g. in compliance with the ISO14443 standard so as to present a range of a few centimeters, i.e. about 1 cm to about 10 cm. Furthermore, the man/machine interface 14 may also include, by way of example, at least one of the following: a keypad, an optionally touch-sensitive screen, means for picking up voice commands, etc.

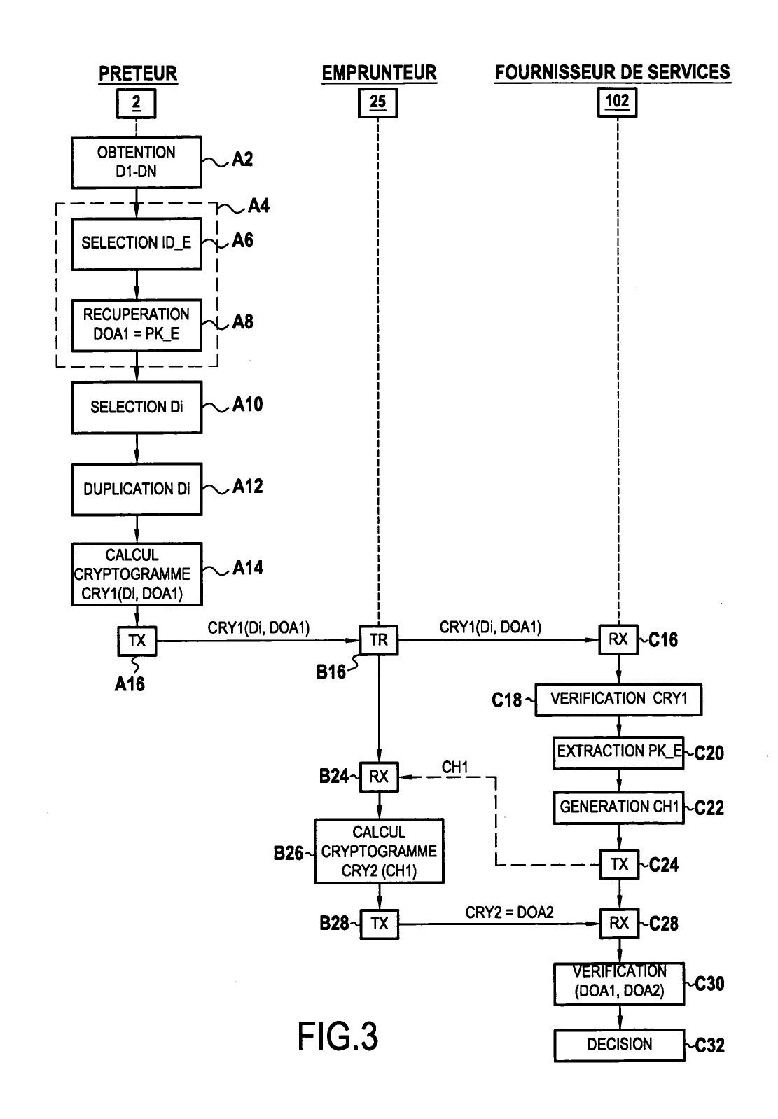

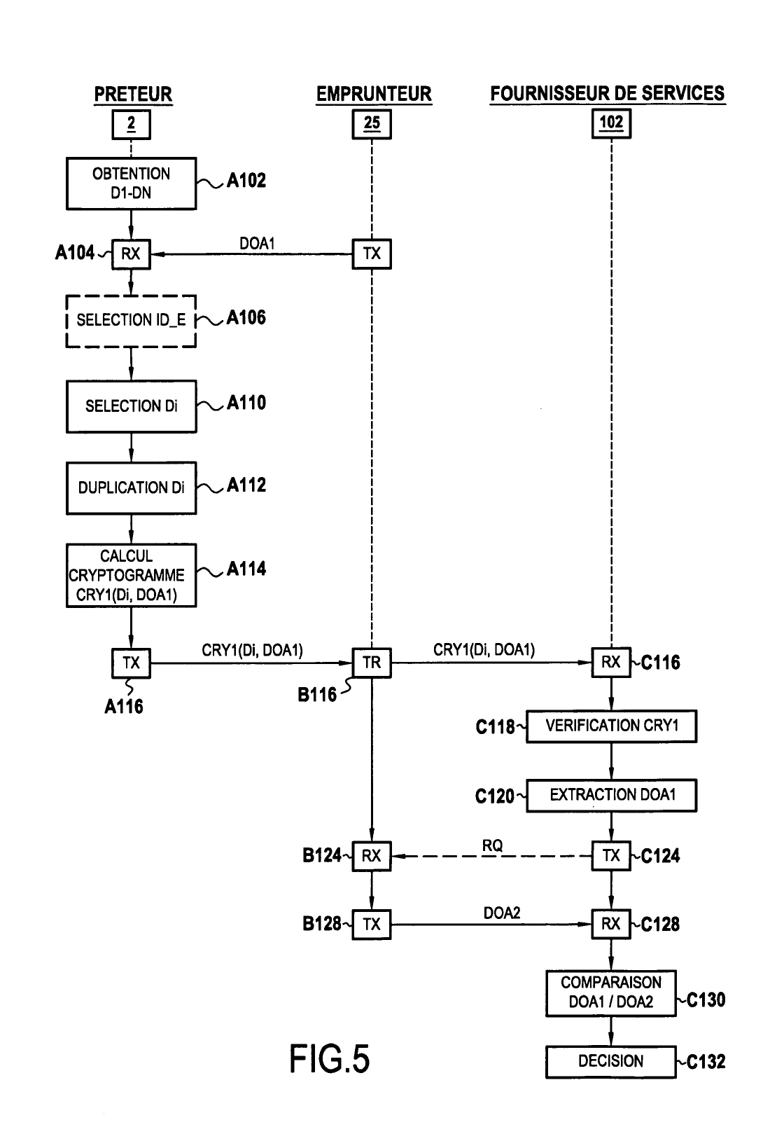

As described below, the EEPROM 8 constitutes a recording (or data) medium in accordance with the invention that can be read by the device 2. It contains a computer program P1 in accordance with a particular implementation of the invention having instructions for executing steps A2-A16 (or A102-A116) of the transfer method shown in FIG. 3 (or respectively in FIG. 5).

The rewritable non-volatile memory 8 is also capable of storing a data table T, as described below.

Analogously, FIG. 1B is a diagram showing the hardware architecture of a service provider (or access provider) in a particular implementation of the invention. In this example, the service provider 102 is a terminal that controls access to services. The terminal comprises a microprocessor 104, a ROM 106, a rewritable non-volatile memory 108 (e.g. an EEPROM), a rewritable volatile memory or RAM 110, and a communications interface 112.

By way of example, the communications interface 112 is a short-range contactless point-to-point communications interface of the NFC (ISO14443 standard) type, for example.

Nevertheless, the interfaces 12 and 112 need not necessarily be NFC interfaces. Other types of interface can be envisaged, such as Bluetooth® or Zigbee interfaces.

In analogous manner, the EEPROM 108 constitutes a recording (or data) medium in accordance with the invention that is readable by the service provider 102. It contains a computer program P2 in accordance with a particular implementation of the invention having instructions for executing steps C16-C32 (or C116-C132) of the access control method shown in FIG. 3 (or respectively in FIG. 5).

In an implementation, a person P constituting the “lender” seeks to lend certain rights to access a given service to a person E constituting the “borrower”. In this example, the lender P seeks to give access to certain functions (or “services”) made available by the lender's vehicle V and for which access is provided by the “service provider” 102.

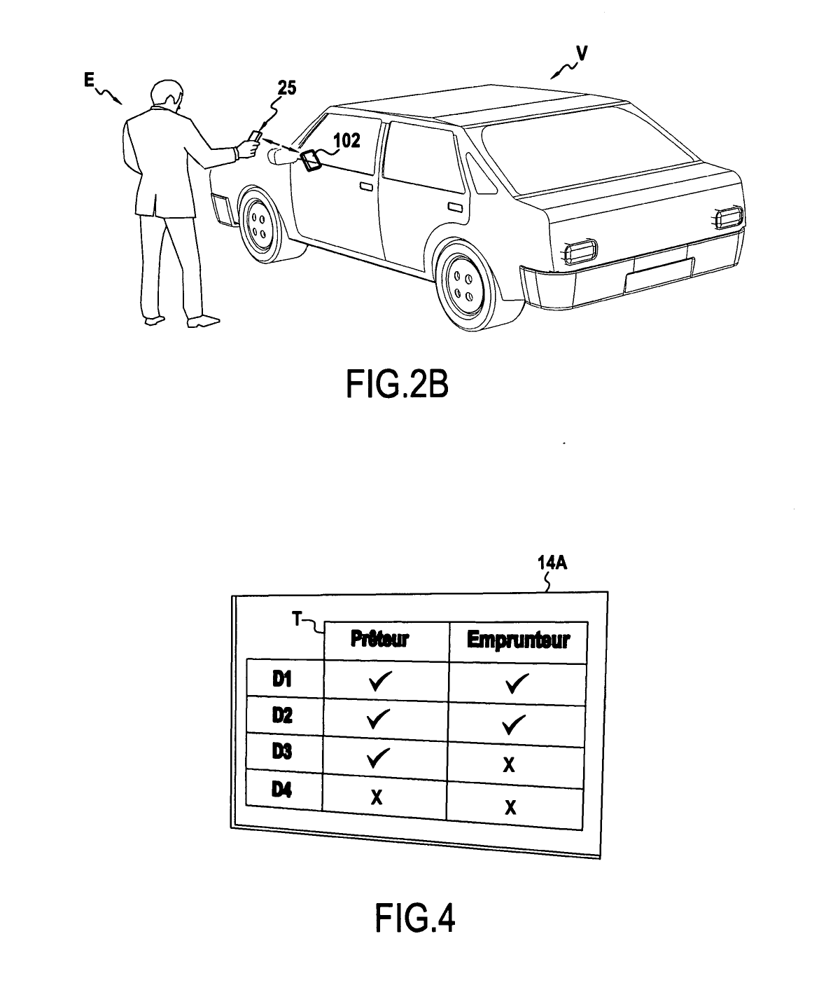

To do this, the lender uses the portable device 2 in particular for selecting at least one access right available to the lender (unless the lender has only a single access right such that such selection is then not necessarily required) and to transfer a corresponding digital key to the device 25 of the borrower E (FIG. 2A). In this example, the hardware architecture of the device 25 is analogous to that of the device 2.

Once these access rights have been obtained, the borrower E can co-operate with the terminal 102 of the vehicle V in order to use those rights and thus access the desired services (FIG. 2B).

A first implementation of the invention is described below with reference to FIGS. 3 and 4 in the context of the above-described example of FIGS. 2A and 2B. More precisely, the device 2 performs the transfer method of the invention by executing the program P1. Likewise, the access provider 102 performs the access control method of the invention by executing the program P2.

During a step A2, the lender P acquires access rights written D1 to DN (where N is an integer) to a service (specifically access to the vehicle V and to some of its services) on the lender's device 2. The presently-described example relates to the device 2 receiving access rights D1, D2, and D3 in which:

D1 corresponds to the right to open the doors of the vehicle;

D2 corresponds to the right to put the vehicle into operation; and

D3 corresponds to the right to use a module for paying road tolls that is under the control of the vehicle V.

By way of example, these access rights D1, D2, and D3 may be in the form of identifiers or tokens (such as character strings, symbols, etc.) that are encoded in some appropriate form and in a given language. For example, it may comprise a variable or a symbol D1 in a string of computer characters. By way of example, the symbol may have the value 1 if the access right is given to the person in question, and it may remain at 0 if the access right is not given. This character string may be in a file.

The device 2 may obtain the access rights D1, D2, and D3 by any appropriate means, such as the communications interface 14, for example. In this example, the device 2 of the lender P obtains the access rights D1, D2, and D3 on being initialized by its manufacturer (or on the premises of the seller of the vehicle V).

The screen 14A shown in FIG. 4 forms part of the man/machine interface 14 and it enables the user to view the list of access rights presently available. In this example, the lender does not have the access right D4. In this example, the device 2 of the lender P has only the access rights D1, D2, and D3. It should nevertheless be observed that the presence Of such a screen 14A in the interface 14 is optional.

In this example, the access rights D1-D3 that have been obtained are stored in a table T in the EEPROM 8 of the device 2 so that the lender P is subsequently capable of using the device 2 to make use of those access rights with the corresponding service provider (i.e. the terminal 102 of the vehicle V). In other words, the lender's device 2 gives access to the services that correspond to the rights D1 to D3 by asserting these rights with the service provider 102 that controls access to the various services of the vehicle V.

During a step A4, the device 2 acquires first identification data DOA1 associated with the device 25 of the borrower E. In this example, during the step A4, the lender P selects (A6) the person to whom rights are to be lent. To do this, the lender selects the identifier ID_E of the borrower E using the man/machine interface 14. By way of example, this selection may be made from among a plurality of prerecorded third party identifiers (e.g. in a list of contacts) that the lender can select in order to identify the device to which rights are to be transferred. Using the selected identifier ID_E, the device 2 recovers (A8) the first authentication data DOA1, which is constituted in this example by a public cryptographic key PK_E associated with the device 25 of the borrower E. The term “associated” is used herein to mean that the public cryptographic key PK_E is issued to third parties by the borrower's device and that it corresponds to a private or secret cryptographic key SK_E held by the borrower's device 25.

By way of example, this public key PK_E is recorded in advance in the EEPROM 8 of the device 2.

It should be observed that selecting an identifier ID_E is not essential in order to obtain the first secret data DOA1 in accordance with the invention. In a variant, the device 2 receives the borrower's public cryptographic key PK_E during the step A4. Such reception may occur, for example, during preliminary pairing between the devices 2 and 25 (e.g. via a short-range point-to-point communications connection, such as an NFC, Bluetooth, or Zigbee type connection). This key PK_E then constitutes the first authentication data DOA1 in the meaning of the invention.

Once the public key PK_E has been recovered, the lender P uses the man/machine interface 14 to select one or more rights that are to be lent to the borrower E from the access rights that are available to the lender, as shown in Table T (FIG. 4). In this example, the lender P selects only the rights D1 and D2. The lender therefore does not seek to enable the borrower E to benefit from the access right D3 that corresponds in this example to making use of the toll payment module.

Nevertheless, it should be observed that such a selection step does not necessarily take place, depending on the implementation of the transfer method that is performed. In particular, in a particular implementation, if the device 2 of the lender P has only one access right, then no selection step is needed: the sole access right is then duplicated during the following duplication step (cf. below). It is also possible to envisage an implementation in which all of the access rights available to the device 2 of the lender P are always duplicated during the following duplication step such that there is no need for any prior step of selecting access rights.

In this example, the lender P is naturally not capable of lending access right D4, since the lender is not authorized to access the corresponding service.

The device 2 then proceeds to duplicate (A12) the selected access rights (D1 and D2). In other words, the device 2 generates copies of the access rights D1 and D2.

The lender P may also be in a position to define other parameters limiting the extent to which the selected rights may be used by the borrower E. For example, the lender may define a utilization time during which at least one of the selected rights cannot be exercised. Under such circumstances, device 2 also generates a time attribute AT that is associated with each selected access right in question (i.e. AT1 for D1 and AT2 for D2). By way of example, the attributes AT1 and AT2 may define a duration, or alternatively a starting time and an ending time for utilization, thereby defining a time period during which exercise of the access right in question is authorized.

Other types of attribute may naturally be envisaged in the context of the invention.

It should be observed that the step A4 may alternatively be performed after the step A10, or indeed after the step A12.

Once the steps A2, A4, A10 and A12 have been performed, the device 2 generates (A14) a message M1 containing the selected access rights D1 and D2, the recovered first authentication data DOA1 (i.e. the public key DK_E in this example) and, where appropriate, all of the attributes (AT1 and AT2, for example) characterizing at least one of the selected rights. The message M1 in this example is in the form of a file.

By way of example, consider the situation in which the lender P seeks to allow access to the inside of the vehicle V (D1) and access to putting the vehicle into operation (D2) for a period of 7 days (AT1=AT2=7 days).

The device 2 then proceeds to calculate (A14) a first cryptogram CRY1 on the basis of the message M1 by using a secret cryptographic key SK_P associated with the device 2 of the lender P. In this example, during this calculation step, the file containing the message M1 is signed using the key SK_P. This secret key SK_P is preferably previously recorded in a memory of the device 2 of the lender P.

The cryptogram CRY1 may include data in the clear (i.e., not encrypted) together with data that has been processed by a cryptographic function in a signature mechanism, or it may contain encrypted data only. In a particular implementation, the secret cryptographic key SK_P of the lender is stored in a secure element (eSE) or in a subscriber identification module (SIM) card inserted in the telephone. This card (or eSE) is then the only entity capable of making the signature by using the key.

The lender's device 2 then transmits (A16) the first cryptogram CRY1 via its communications interface 12 to the device 25.

By way of example, this transmission is performed when pairing the devices 2 and 25 while these two devices are communicating via a short-range point-to-point communications connection, e.g. of the NFC type. Alternatively, it is possible to use the Bluetooth or Zigbee standards.

The borrower's device 25 then stores the cryptogram CRY1.

The borrower E can subsequently exercise the received access rights with the appropriate service provider, i.e. with the terminal 102 of the vehicle V. To do this, the borrower E brings the device 25 into communication range of the service provider 102, as shown in FIG. 2B.

During a step B16, the device 25 transmits the cryptogram CRY1 to the terminal 102, which receives it (C16) via its communications interface 112. This transmission may likewise take place via a short-range point-to-point communications connection, e.g. of the NFC type (or alternatively of the Bluetooth or Zigbee type).

The terminal 102 then proceeds with two authentication steps, namely firstly authenticating (C18) the lender's device, and secondly authenticating (C20 to C30) the borrower's device or the borrower in person.

More precisely, in the step C18 of authenticating the device 2 of the lender P, the terminal 102 proceeds to authenticate the received cryptogram CRY1. In this example, authentication consists in verifying the signature of the cryptogram CRY1 in order to verify that the cryptogram does indeed come from the device 2 of the lender P. Typically, the lender P is the owner of the vehicle and the terminal must make sure that it is indeed the lender P who has agreed to allow access to the services defined by D1 and D2.

In this example, the signature of the cryptogram CRY1 is verified by means of the public cryptographic key PK_P of the lender P that the terminal 102 of the vehicle V has previously obtained. This public key PK_P is preferably pre-recorded in a memory of the terminal 102.

In a particular implementation, the terminal 102 is suitable for obtaining this public key PK_P from a remote server (e.g. via mobile Internet) by interrogating an appropriate certification authority (CA). This may be done before or after receiving the cryptogram CRY1.

In the presently-described example, verification of the signature (and thus of the authenticity of the cryptogram CRY1) is positive only if the cryptogram CRY1 was previously signed using the secret key SR_P matching the public key PK₁₃ P. If so the cryptogram CRY1 is successfully authenticated by the terminal 102 as initially coming from the device 2 of the lender P.

In a variant, the signature of the cryptogram CRY1 is verified using a secret cryptographic key identical to the cryptographic key SK_P of the lender P. Under such circumstances, the device 2 and the access provider 102 share the same cryptographic key SK_P. The cryptogram CRY1 will then be successfully authenticated as coming from the device 2 only if it was previously signed using the secret key SK_P identical to the secret cryptographic key head by the terminal 102. Once the lender's device 2 has been successfully authenticated, the terminal 102 extracts (C20) from the cryptogram CRY1 the first authentication data DOA1, i.e. the borrower's public cryptographic key PK_E in this example.

In this implementation, the terminal 102 then recovers (C22) a character string CH1. This character string CH1 may be generated by the terminal 102 in optionally random manner or it may be recovered in any appropriate manner.

The terminal 102 then sends (C24) this character string CH1 to the device 25 in order to authenticate it. This enables the terminal 102 to ask the device 25 to sign the character string CH1 by means of its secret cryptographic key SK_E that matches the public key PK_E.

In this example, the device 25 signs (B26) the character string CH1 using the secret key SK_E, and then it sends (B28) the signed character string in the form of a second cryptogram CRY2 to the device 102. In this example, the cryptogram CRY2 constitutes authentication data DOA2 for authenticating the device 25 of the borrower E. This authentication data DOA2 thus constitutes second authentication data in the meaning of the invention.

Thereafter, the terminal 102 verifies the authenticity of the device 25 in a step C30 of using the first authentication data DOA1 (i.e. the public key PK_E extracted from the cryptogram CRY1 in this example) to verify the signature of the cryptogram CRY2 received in step C28. In other words, the device 25 is authenticated on the basis of the authorization data DOA1 and the authentication data DOA2.

The device 25 is authenticated successfully only if the character string received in the form of the second cryptogram CRY2 was signed with the secret key SK_E that matches the public key PK_E that the terminal 102 extracted in step C20.

In step C32, the terminal 102 decides to allow access to the services matching the access rights D1 and D2 extracted from the first cryptogram CRY1 if, and only if, both the authentication of the device 2 of the lender P (C18) and the authentication of the device 25 of the borrower E (C20-C30) have taken place successfully.

If the signature verification in step C18 fails, the terminal 102 refuses access to the requested services without there being any need to proceed to the following step. If the result of the verification of the signature in step C30 is negative, then access to the services is likewise refused.

Once access has been authorized, the borrower E is in a position to benefit from the services corresponding to the access rights D1 and D2. Where appropriate, access to these services is controlled by the terminal 102 in compliance with the attributes extracted from the encrypted message M1. In this example, the terminal 102 limits the exercise of the rights D1 and D2 in compliance with the associated time attributes, namely AT1 and AT2 respectively.

It should be observed that the stage of authenticating the device 25 of the borrower E may also include the terminal 102 sending a request for a confidential code or a biometric check of the device in order to verify the authenticity of the holder of the device 25. This step advantageously makes it possible to avoid the device 25 being lent to or stolen by some other party.

Furthermore, in order to be certain that the public key PK_E of the borrower is authentic (and thus avoid possible “man in the middle” type attack), it is possible to envisage involving a certification authority in charge of validating public keys in a given territory (in accordance with the particular implementation mentioned above).

Alternatively, in order to avoid a “man in the middle” type attack, the public keys PK_P and PK_E are exchanged between the devices 2 and 25 during a preliminary step of pairing these two devices, as described above.

In this first implementation, the device 2 of the lender P Is preferably an NFC mobile appliance. The device 25 of the borrower is preferably an NFC mobile appliance or an NFC card such as a driver's license or an identity card, for example. In a variant, the NFC standard may be replaced by the Bluetooth standard or the Zigbee standard.

A second implementation of the invention is described below with reference to FIGS. 4 and 5 in the context of the above-described example of FIGS. 2A and 2B. For this purpose, the device 2 performs the transfer method of the invention by executing the program P1. Likewise, the access provider 102 performs the access control method of the invention by executing the program P2.

During a step A102, the lender P causes the device 2 to acquire rights D1 to DN giving access to respective services. Once more the example described involves the device 2 receiving the above-defined access rights D1, D2, and D3.

After the lender's device 2 has obtained (A102) the access rights D1, D2, and D3, it receives (A104) the first authentication data DOA1 from the borrower. In this example, obtaining DOA1 does not require the lender P to begin by using the device 2 to select an identifier of the device 25. By way of example, the authentication data DOA1 is obtained while pairing the devices 2 and 25 for short-range point-to-point communications (e.g. of the NFC, Bluetooth, or Zigbee type).

Thereafter, the first authentication data DOA1 is stored in a memory of the device 2 of the lender P. In this second implementation, the authentication data DOA1 is an identification number associated with the device 25 of the borrower E. For example, it may comprise a serial number specific to the device 25.

Thereafter, the transfer method comprises the steps of selecting access rights (A110), of duplicating the selected rights (A112), of calculating a first cryptogram CRY1 from the secret cryptographic key SK_P and of generating a message M1 containing the first secret data DOA1 and the duplicated access rights (i.e. D1 and D2 in this example, together with associated attributes, where appropriate) (A114), and of sending (A116) the cryptogram CRY1 to the device 25 of the borrower E. These steps are performed identically to the steps A10, A12, A14, and A16, respectively.

Nevertheless, in analogous manner to the implementation of FIG. 3, the step A110 of selecting at least one access right Di is not essential.

In an alternative to this second implementation, the device 2 may receive (A104) a plurality of first authentications DOA1 corresponding to a plurality of devices of the borrower, with these authentifications being stored in an appropriate memory. The transfer method then also includes, after receiving the first authentication data DOA1, a step A106 of the lender P using the device 2 to select an identifier ID_E. The device 2 then recovers the first authentication data DOA1 that is associated with the selected identifier ID_E.

As in the first implementation, the device 25 of the borrower E then transmits (B116) the first cryptogram CRY1 to the access provider 102, or more precisely to the terminal 102 of the vehicle V.

The device 102 proceeds to authenticate the device 2 in the same manner as the above-described first implementation, i.e. using the public cryptographic key PK_P of the lender to verify the signature of the received first cryptogram CRY1, this key PK_P matching the secret cryptographic key SK_P previously used by the device 2 for calculating the cryptogram CRY1.

Once the device 2 has been authenticated (C118), the terminal 102 extracts (C120) the first authentication data DOA1 from the first cryptogram CRY1.

Thereafter, the device 102 sends (C124) a request RQ to the device 25 asking it to provide its second authentication data DOA2.

In response, the device 25 thus sends (B128) its second authentication data DOA2 to the terminal 102. In this second implementation, this second authentication data DOA2 as transmitted in step B128 is an identification number associated with the device 25 of the borrower E.

It a variant, it should be observed that the terminal 102 does not send any request RQ: the device 25 spontaneously sends (B128) the second authentication data DOA2 to the terminal 102.

During a step C130, the terminal 102 then compares the second received authentication data DOA2 with the first authentication data DOA1 as extracted from the cryptogram. CRY1 so as to authenticate the device 25 of the borrower E. In this example, this comparison consists in verifying that the authentications DOA1 and DOA2 as obtained are identical. Nevertheless, in the context of the invention, it is possible to envisage using other types of correspondence tests.

If the comparison makes it possible to establish that DOA1 and DOA2 correspond (i.e., in this example, that DOA1 and DOA2 are identical), then the authentication of the device 25 is positive.

Thereafter, the terminal 102 performs a decision step C132 identical to the above-described step C32. Access to the services corresponding to the access rights extracted from the received cryptogram CRY1 is allowed only if the authentication of the device 2 of the lender and the authentication (C120-C130) of the device 25 of the borrower E have both taken place successfully.

In this second implementation, the device 2 of the lender P is preferably an NFC mobile appliance. The device 25 of the borrower is preferably an NFC mobile appliance or an NFC card such as a driver's license or an identity card, for example. Alternatively, the NFC standard may be replaced by the Bluetooth standard or the Zigbee standard.

In a variant of the second implementation, the first authentication data received in step A104 is a biometric signature (or data item) associated with the borrower in person. By way of example, such a signature corresponds to capturing a fingerprint or a photograph of the borrower E.

The lender's device 2 may also include means for capturing a biometric signature of the borrower. These means thus make it possible to obtain the first authentication data DOA1 in step A104. By way of example, these means may comprise a camera for capturing an image of the face of the borrower E or of the borrower's driver's license. Alternatively, these means may comprise a reader suitable for capturing fingerprints. It is also possible to envisage using several types of biometric signature capture means in combination.

In this variant, the second authentication data DOA2 transmitted by the borrower in step B128 must consequently correspond with the appropriate biometric signature of the borrower E in order for the device 25 to be positively authenticated in step C130. The service provider may also include appropriate means for capturing the biometric signature of the borrower E during the stage of authenticating the device 25.

In summary, the invention thus makes it possible for a holder of rights to access a service to transfer at least some of those rights to a trusted third party in a form of a loan. This transfer is performed using devices and a service provider as described above.

The term “loan” is used herein to mean that access rights are duplicated and then transferred from a lender to a borrower so that both parties can exercise the rights in question with the corresponding service. In other words, transferring a right does not deprive the lender of the right in question.

Advantageously, the invention enables the lender and the borrower to conserve their respective devices. The lender transfers access rights from the lender's device to the borrower's device, and the borrower can then exercise those rights using that device with the service in question. An occasional user of a service can thus benefit from certain rights that are lent for that purpose.

Advantageously, the invention enables the lender to personalize the loan by selecting at will at least one access right from amongst the rights available to the lender at the time of selection. The context in which each of those rights is to be used can also be defined more accurately by using the lender's device to define attributes that are associated with the selected access rights. In particular, the loan of an access right may be made conditional on a time limit. Nevertheless, it is also possible to envisage that a right is transferred on a permanent basis.

The invention preferably makes use of short-range point-to-point communications interfaces (preferably of the NFC, Bluetooth®, or Zigbee type) to conduct the communications in the methods of the invention between the borrower's device and the lender's device, and also between the borrower's device and the access provider.

In this way, there is no need for any communications network (e.g. of the LAN, WLAN, or PSTN type) in order to conduct communications during the methods of the invention.

Advantageously, the invention makes it possible to prevent the borrower from lending access rights in turn to a third party unknown to or not authorized by the lender. Even if the borrower manages to transmit rights that were transferred by the initial lender to a third party, the step of authenticating the borrower's device as performed during the access control method of the invention would serve to detect the third party's device as being not authorized to access the requested service. The access provider blocks access to the requested right if authentication of the borrower's device fails.

The invention finds a particular application in lending access rights to a service provider such as vehicle or any other appropriate equipment.

The invention may also apply advantageously to applications of the sponsoring type (e.g. concerning Internet services). Sponsoring consists in giving a right to a third party that the third party can then use with a service provider. The signature of the lender (the sponsor) then enables a bonus to be allocated to the lender.

1. A transfer method for transferring a right to access a service to a device of a borrower, the method being performed by a device of a lender, comprising:
holding at least one access right to access a service enabling the lender's device to access the service in accordance with said at least one access right;
obtaining authentication data associated with the borrower or with the borrower's device;
duplicating said at least one access right;
using a cryptographic key associated with the lender's device to calculate a cryptogram from a message containing the authentication data and said at least one duplicated access right; and
sending the cryptogram to the borrower's device in order to transfer the duplicated access right thereto.

2. A transfer method according to claim 1, wherein the cryptogram is sent via an NFC, Bluetooth®, or Zigbee short-range point-to-point communications connection.

3. A transfer method according to claim 1, further including selecting an identifier of the borrower's device wherein the authentication data is obtained from the selected identifier and corresponds to a public cryptographic key associated with the borrower's device.

4. A transfer method according to claim 1, wherein the authentication data is an identity code received from the borrower's device.

5. A transfer method according to claim 1, further including selecting an identifier of the borrower's device, wherein the authentication data is obtained from the selected identifier and corresponds to a biometric signature of the borrower.

6. A transfer method according to claim 1, wherein the cryptographic key associated with the lender's device is a secret cryptographic key.

7. A computer program including instructions for executing steps of a transfer method according to claim 1 when said program is executed by a computer.

8. A computer readable recording medium having recorded thereon a computer program including instructions for executing steps of a transfer method according to claim 1.

9. A control method for controlling access to a service, the method being performed by a service provider, comprising:
receiving a first cryptogram from a device of a borrower, the first cryptogram being calculated on the basis of a first cryptographic key associated with a device of a lender, said first cryptogram comprising first authentication data associated with the borrower or with the borrower's device together with at least one access right transferred by the lender's device to give access to a service;
authenticating the first cryptogram using a second cryptographic key matching said first key in order to verify that said first cryptogram does indeed come from the lender's device;
authenticating the borrower or the borrower's device by receiving second authentication data of the borrower or of the borrower's device and verifying the authenticity of the borrower's device from the first authentication data extracted from said first cryptogram and from the received second authentication data; and
deciding to allow the borrower access to the service in compliance with said at least one transferred access right if, and only if, said authentication steps take place successfully.

10. A control method according to claim 9, wherein the first cryptogram from the borrower's device and the second authentication data are received via a short-range point-to-point communications connection complying with the ISO14443, Bluetooth®, or Zigbee standard.

11. A control method according to claim 9, wherein the first key associated with the lender's device is a secret cryptographic key and the second key is a public cryptographic key matching said secret key.

12. A control method according to claim 9, wherein the second authentication data is a second cryptogram coming from the borrower's device, and wherein verification of the authenticity of the borrower's device comprises verifying the received second cryptogram using the first authentication data as extracted from the received first cryptogram, said first authentication data being a public cryptographic key that is associated with the borrower's device.

13. A control method according to claim 9, wherein the first authentication data extracted from the first cryptogram is a first identity code and the received second authentication data is a second identity code, and wherein verification of the authenticity of the borrower's device comprises comparing the first and second identity codes.

14. A control method according to claim 9, wherein the first authentication data extracted from the received first cryptogram is a first biometric signature, and the received second authentication data is a second biometric signature, and wherein the authenticity of the borrower's device is verified by comparing the first and second biometric signatures.

15. A method of managing a transfer of at least one access right giving access to a service, the method comprising:
transferring at least one access right to a service to a device of a borrower, the method being performed by a device of a lender in accordance with claim 1;
transferring said at least one access right from the device of the borrower to an access provider; and
the access provider controlling access of the borrower to the service in accordance with claim 9.
